(19) United States
(12) Patent Application Publication
(10) Pub. No.: US 2026/0349274 A1
(43) Pub. Date: Nov. 5, 2026

(54) SPECTACLE LENS BLANK FOR MANUFACTURING SPECTACLE LENSES

(71) Applicant: Roland Mandler GmbH & Co. KG, Heuchelheim (DE)

(72) Inventor: Roland MANDLER, Heuchelheim (DE)

(73) Assignee: Roland Mandler GmbH & Co. KG, Heuchelheim (DE)

(21) Appl. No.: 19/642,977

(22) Filed: Apr. 9, 2026

(30) Foreign Application Priority Data
Apr. 16, 2025 (EP) 25170875.6
Apr. 16, 2025 (EP) 25170882.2
Mar. 20, 2026 (EP) 26166537.6
Mar. 20, 2026 (EP) 26166538.4

(51) Int. Cl. G02C 7/02

(52) U.S. Cl. CPC G02C 7/02

(57) ABSTRACT

A spectacle lens blank for manufacturing spectacles lenses is formed from a lens element and an annular holder, in which the annular holder has a thickness which is at least partially smaller than the thickness of the lens element of the spectacle lens blank and the annular surface delimiting the lens element in the radial direction is formed with a height between the lens element and the annular holder..

### CROSS REFERENCE TO RELATED APPLICATIONS

Applicant claims priority under 35 U.S.C. §119 of European Application No. 25170875.6 filed on Apr. 16, 2025; European Application No. 25170882.2 filed on Apr. 16, 2025; European Application No. 26166537.6 filed Mar. 20, 2026; and European Application No. 26166538.4 filed Mar. 20, 2026, the disclosures of which are incorporated by reference.

### BACKGROUND OF THE INVENTION

### 1. Field of the Invention

The invention relates to a spectacle lens blank for manufacturing spectacle lenses.

### 2. Description of the Related Art

Spectacle lenses and other optical shaped bodies consist primarily of plastics which have a low specific gravity and a high index of refraction and are easily machinable. To simplify the language, instead of "spectacle lenses and other shaped bodies," reference will be made in the following only to spectacle lenses, but this always means "other shaped bodies with similar properties."

As is known from DE 10 2008 064 333 A1, spectacle lens blanks are fixed in a clamping or retaining system and then brought to the target geometry using a plurality of material-removing processing steps on Computer Numerical Control (CNC) machines. The starting point is typically a semi-formed or pre-formed spectacle lens blank ("blank") having an already optically effective surface on one side, the second surface of which and the rim of which are processed by milling, turning, grinding, fine grinding and, optionally, polishing. Rim processing steps are also carried out in order to proceed from a raw diameter to the final diameter. Subsequent coating processes (hard coating, anti-reflective) are carried out. For this processing, according to this prior art, a lens carrier for the blocking is disclosed, which lens carrier retains the spectacle lens blanks for processing. This method belonging to the prior art requires that an adapted lens carrier must be made available for each prefabricated lens shape. Furthermore, the spectacle lens blank must be fastened to the lens carrier with adhesive and removed after the processing.

In order to avoid a complex blocking method, the prior art (DE 10 2007 040 395 A1) makes known a block-free production of single-strength or multi-strength spectacle lenses. For this purpose, the spectacle lens blank is arranged in a clamping device. In this block-free method, the spectacle lens blank is clamped in a standard ring using an O-ring. The clamping ring is reusable and can be clamped together with the inserted spectacle lens blank in the clamping device of, for example, CNC processing machines. The spectacle lens blank is then held in the clamping ring during all processing steps. In this method belonging to the prior art, clamping rings must be made available for the plurality of spectacle lens blanks to be processed at the same time. Moreover, the spectacle lens blanks must be fastened in the clamping rings with the O-ring.

The prior art (DE 10 2010 061 056 A1) also includes a method for manufacturing cost-optimized spectacle lenses. According to this prior art, two lens elements are arranged in one spectacle lens blank, whereby lower storage and transport costs are incurred. In this spectacle lens blank belonging to the prior art, after the processing of the lens elements, a large amount of rim material is removed. The rim material consists of the same expensive material as the lens elements. This material is discarded after the spectacle lens blank is processed, such that the costs of the spectacle lenses manufactured according to this method are very high.

The spectacle lens blanks known from practical application weigh between 40 and 60 grams. The finished spectacle lens weighs between 7 and 9 grams. This means that 30 to 60 grams of material (plastic or glass) are discarded.

According to the prior art (DE 103 38 893 B4, WO 2005/018919 A1), a method for manufacturing spectacle lenses is known, in which the plastic molded parts have a diameter-enlarging clamping ring and are clamped on the outer circumference of the clamping ring during all processing steps. The clamping ring and the lens element are interconnected and together form a plastic circular blank. The plastic circular blanks consist of two permanently interconnected plastics, with an inner lens element made of high-quality material and a concentrically surrounding clamping ring made of less expensive material, which effects the increase in diameter. The clamping ring acts as a continuous clamping and set-down surface during production and is removed together with a narrow rim region of the lens element from the finished spectacle lens only after completion of the essential processing steps. In this method belonging to the prior art, it is necessary to manufacture the spectacle lens blank from two different materials. This manufacture of a spectacle lens blank with an expensive lens element and an inexpensive clamping ring is highly complex in comparison to a single-piece plastic blank. Additional process steps that must be coordinated with one another are necessary to manufacture and integrally bond the two different plastic parts by casting or injection molding the clamping ring to the lens element or by adhering or welding or overmolding the clamping ring to the lens element, whereby the manufacturing process becomes more complex and thus more costly and time-consuming.

### SUMMARY OF THE INVENTION

The technical problem addressed by the invention consists of providing a spectacle lens blank which has a holding ring for the processing in various processing steps and which is cost-effective at the same time.

This technical problem is solved by a spectacle lens blank having the features according to the invention.

The spectacle lens blank according to the invention for manufacturing spectacle lenses, which is formed from a lens element and an annular holder, in which the lens element and the annular holder are formed from the same material, is characterized in that an annular surface delimiting the lens element in the radial direction is formed with a height between the lens element and the annular holder, and in that the annular holder has a thickness that is at least partially smaller than the height of the annular surface.

Spectacle lens blanks are usually cast with plastic.

In principle, the spectacle lens blank can alternatively consist of glass.

The spectacle lens blank according to the invention has a lens element and an annular holder. Advantageously, the annular holder encompasses the lens element. Particularly advantageously, the annular holder is arranged concentrically around the lens element.

The lens element and the annular holder, i.e. the entire spectacle lens blank, consist, according to the invention, of one and the same material.

In order to ensure that the spectacle lens blank according to the invention is cost-effectively constructed, the thickness of the annular holder is at least partially smaller than the height of the annular surface of the spectacle lens blank delimiting the lens element in the radial direction.

According to the invention, the spectacle lens blank is formed from the lens element and the annular holder. Lens element and annular holder consist of the same material.

No distinction is made between an inexpensive material for an annular holder and an expensive material for the lens element.

An annular surface is formed between the lens element and the annular holder. This is an imaginary annular surface in the spectacle lens blank, since lens element and annular holder consist of one and the same material. This annular surface becomes an outer surface in the radial direction of the spectacle lens blank when the annular holder is removed after the various processing steps of the lens element.

This annular surface has a height. The height of the annular surface is oriented in the axial direction of the spectacle lens blank.

According to the invention, the annular holder has a thickness that is at least partially smaller than the height of the annular surface.

Due to this design of the spectacle lens blank, a considerable amount of material can be saved in the region of the annular holder. Since the annular holder and the lens element consist of one and the same material, the manufacture of the spectacle lens blank is simplified, since the lens element and the annular holder can be formed in one work step, i.e. for example, in a casting process. Alternatively, there is also the possibility to cast the lens element first and then cast on the annular holder.

Especially in the region of the annular holder, according to the invention, a considerable amount of material can be saved, since the annular holder has a smaller thickness at least in parts.

The annular holder has the function of holding spectacle lens blanks during the various processing operations.

The annular holder can be fixed in a clamping or retaining system and the lens element of the spectacle lens blank can be brought into a target geometry in various processing steps, for example material-removing processing steps on, for example, CNC machines.

The spectacle lens blank is advantageously a semiformed or preformed spectacle lens blank having an optically effective surface on one side, the second surface of which is processed by milling, turning, grinding, fine grinding and/or, optionally, polishing.

In principle, a spectacle lens blank which is processed on both sides can also be used.

After the processing of the lens element in the spectacle lens blank, rim processing steps are carried out, in which the annular holder is removed in order to obtain the final diameter of the spectacle lens to be manufactured.

Subsequently, coating processes such as hard coating or anti-reflective coating can also be carried out.

Since the annular holder is removed anyway after the various processing steps, there is the possibility to configure this annular holder to be as thin as possible in order to save material.

With the spectacle lens blank according to the invention, 30,000 tons of material can be saved per year.

According to a particularly advantageous embodiment of the invention, it is provided that the spectacle lens blank with the annular holder and the lens element is designed as a cast spectacle lens blank.

The spectacle lens blank is advantageously designed as a cast spectacle lens blank. This allows the spectacle lens blank with the annular holder and the lens element to be manufactured in a particularly simple and cost-effective manner.

Particularly advantageously, the annular holder is also designed with the at least partially smaller thickness than the height of the annular surface directly in the casting process.

According to a particularly preferred embodiment of the invention, it is provided that the lens element and the annular holder are formed as one piece. This allows work steps due to the casting-on or any other type of fastening of an annular holder to be avoided.

According to a further advantageous embodiment of the invention, it is provided that the spectacle lens blank with the lens element and the annular holder is designed as a spectacle lens blank cast in a casting process.

Due to this embodiment, work steps are saved. The spectacle lens blank with the lens element and the annular holder is manufactured, namely cast, in a single casting process.

This also allows stresses between the lens element and the annular holder to be avoided.

A further advantageous embodiment of the invention provides that the thickness of the annular holder is smaller over an entire radial extent of the annular holder than the height of the annular surface delimiting the lens element in the radial direction.

Due to this embodiment, a particularly large amount of material is saved.

The annular holder advantageously has a thickness which ensures stable retention of the spectacle lens blank during the various processing processes. For the stable retention, a specified minimum rim thickness of the annular holder is advantageously provided. The spectacle lens blank is fixed with the annular holder in the processing device or the processing devices.

The greatest saving is achieved when the annular holder advantageously has a thickness in its entire radial extent around the longitudinal axis of the spectacle lens blank which is smaller than the height of the annular surface between the lens element and the annular holder.

According to a further particularly preferred embodiment of the invention, it is provided that the annular holder is designed as a flange.

The flange is advantageously formed as one piece with the lens element in the casting process.

In principle, there is also the possibility to retroactively cast-on the flange.

The design as a flange has the advantage that a particularly large amount of material is saved. In this case, there is not as much "sacrificial material" present.

According to a further advantageous embodiment of the invention, it is provided that the flange is designed as a plane parallel flange or as a flange tapering on one side or as a flange tapering on both sides.

These embodiments have the advantage that the flange has planar support surfaces for a clamping device in a processing device. Alternatively, the flange can taper in the direction of the lens element or in the direction of the rim. The tapering can be provided on one side of the flange. Alternatively, the tapering can be provided on both sides of the flange. If the tapering is provided on both sides of the flange, the flange advantageously tapers toward an outer diameter of the spectacle lens blank.

According to a further advantageous embodiment of the invention, it is provided that the annular holder has at least one indentation on at least one side.

Material is also saved due to the at least one indentation.

In the case of a spectacle lens blank which has a prefabricated side, the indentation is particularly advantageously formed on the prefabricated side. The indentation is also formed directly in the annular holder during the casting process.

In principle, there is also the possibility that the annular holder has at least one indentation on both sides. This allows an even greater amount of material to be saved.

With respect to the spectacle lens blank according to the invention, it is essential that the indentation is formed directly during the process of manufacturing the spectacle lens blank.

The indentation is not formed by subsequent milling or processing operations. This would not result in material saving.

A further advantageous embodiment of the invention provides that a radius is formed between the lens element and the annular holder on one side or both sides of the spectacle lens blank. A soft transition is advantageously provided between the lens element and the annular holder.

A soft transition is the absence of an edge or the like.

This embodiment can be advantageous in various processing operations, since the spectacle lens blank can be processed up to the rim of the lens element or beyond the rim of the lens element in the direction of the annular holder.

According to another advantageous embodiment of the invention, it is provided that an edge is formed between the lens element and the annular holder on one side or both sides of the spectacle lens blank.

The design with the edge can also be advantageous in various processing operations. In particular, an edge defines the finished dimension of the lens element, advantageously plus a processing dimension, in order to be able to subsequently fit the lens element in a spectacle frame.

According to a further advantageous embodiment of the invention, it is provided that a radius is formed between the lens element and the annular holder on one side of the spectacle lens blank and that an edge is formed between the lens element and the annular holder on the opposite side of the spectacle lens blank.

This embodiment can also be advantageous in various processing operations. In this embodiment as well, the delimitation of the lens element in relation to the finished dimension is visible.

A further advantageous embodiment of the invention provides that the annular holder is arranged parallel to or at an angle to a horizontal of the spectacle lens blank. This embodiment is particularly advantageous when the annular holder is designed as a flange. The spectacle lens blank is advantageously disk-shaped. Due to the disk, a horizontal is established.

The annular holder is advantageously oriented parallel to the horizontal. Alternatively, there is also the possibility to orient the annular holder at an angle to the horizontal.

This embodiment can be advantageous depending on various processing devices or depending on various chucks or retainers of a processing device.

According to a further advantageous embodiment of the invention, the spectacle lens blank has two surfaces and the first surface of the spectacle lens blank is designed as a surface to be processed.

Spectacle lens blanks are frequently designed as prefabricated spectacle lens blanks. In this case, one side already has the required optical properties due to the casting process. Only the second side is processed. This allows processing time to be saved.

If a prefabricated side is present, the indentation is preferably arranged on the prefabricated side.

According to an advantageous embodiment of the invention, the indentation has a radius. This means that this is an indentation having a semi-circular cross-section. Alternatively, the indentation can be an indentation having a curved cross-section. This is then an indentation having a parabolic or elliptical cross-section.

Particularly advantageously, it is provided that a curved indentation is provided when a soft transition is provided between the lens element and the annular holder on the opposite side.

If the annular holder is designed as a planar annular holder, for example in the form of a flange, an edge is advantageously provided between the lens element and the annular holder. In this case, the rim of the lens element, i.e. of the subsequent spectacle lens, is recognizable.

According to a further advantageous embodiment of the invention, the lens element, i.e. the functional glass, protrudes beyond the blank.

According to an advantageous embodiment, it is possible that a cast-on indentation is provided on both sides.

According to a further advantageous embodiment of the invention, the rim of the spectacle lens blank has a thickness from 1.1 to 1.5 millimeters. Preferably, a thickness of 1.2 millimeters is provided.

If the annular holder has an indentation on one side or an indentation on each of the two sides, the rim of the annular holder is formed thicker than the thickness of the annular holder in the region of the one indentation or the two indentations.

According to the advantageous embodiment having an indentation on one side or having an indentation on each side, the rim of the annular holder is thicker than the narrowest point of the annular holder. This allows particularly good holding properties to be achieved in the various processing devices.

In the spectacle lens blank according to the invention, two surfaces for forming the optical effect are advantageously provided. One of the surfaces is the so-called "prescription surface." This surface is processed. In order to increase the economic efficiency, advantageously only the side of the spectacle lens blank that will also be actually needed later as the spectacle lens is processed. The other side of the spectacle lens blank is already finished.

The interaction of the optical properties of the front side and the back side yields a spectacle lens with an ideal adaptation to the prescription from an opthalmologist (production according to a prescription).

The special geometry of the front side (prescription surface) is advantageously configured in such a way that the overall effect of the spectacle lens as viewed from the front also satisfies aesthetic considerations. This means, for example, that distorted imaging properties do not occur when looking through from the front. This also applies when the optical effect for the distance portion and the near portion is optimized (bifocal, progressive) and a thickness optimization is carried out with adaptation to the spectacle frame and an adaptation of the relative position of the lens axes with respect to the eye (customized lenses) for these spectacle lenses.

During the manufacture of plus lenses (lens center is thicker than lens rim) and with neutral lenses (lens center has the same thickness as lens rim), it is necessary to ensure that the thickness of the lenses is reduced to the greatest extent possible with respect to the remaining rim thickness, i.e. the thickness at the peripheral edge of the finished spectacle lens. The rim thickness must be maintained so that the lens can be easily mounted in the spectacle frame, i.e. this thickness must approximately correspond to the width of the frame of the spectacle frame.

In minus lenses (lens center is thinner than lens rim), the thickness of the lenses is reduced within the scope of a thickness optimization to the greatest extent possible with respect to the remaining thickness in the lens center. A certain minimum thickness in the lens center is required so that the mechanical stability of the spectacle lens is ensured.

With the spectacle lens blank according to the invention, production according to a prescription is particularly easily possible. Due to the special geometry on one lens side (preferably front side), machining can be carried out with coarse graduation also in production according to a prescription with semi-finished plastic blanks (semi-finished parts). This minimizes the production costs, since only one side of the spectacle lens blank is processed and storage costs are required for fewer semi-finished parts due to the large graduation.

With the spectacle lens blank according to the invention, 40 to 50% of material can be saved.

The spectacle lens blank according to the invention also has the advantage that the surface to be processed is approximately 30% smaller than in the spectacle lens blanks known from practical application. This allows the processing times, for example the milling or polishing, to be shortened.

In the subsequent coating as well, the spectacle lens blank according to the invention has the advantage that the spectacle lens blank is easier to handle due to the annular holder and that the filling of anti-reflective coating calottes can be automated, because the annular holder can be fixed at a standard size, i.e. a uniform diameter.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows a longitudinal section through a spectacle lens blank according to the invention;

FIG. 2 shows a modified exemplary embodiment;

FIG. 3 shows a modified exemplary embodiment;

FIG. 4 shows a modified exemplary embodiment;

FIG. 5 shows a modified exemplary embodiment;

FIG. 6 shows a modified exemplary embodiment; and

FIG. 7 shows a modified exemplary embodiment.

### DETAILED DESCRIPTION OF PREFERRED EMBODIMENTS

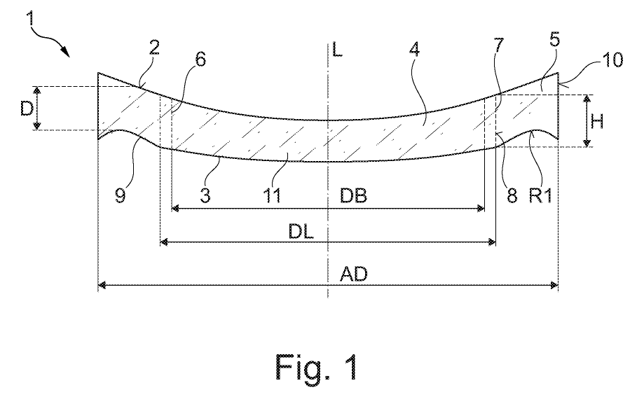

FIG. 1 shows a spectacle lens blank 1 which has a front side 2 and a back side 3. The back side 3 is a finished cast side which will not be further processed apart from possible polishing or coating processes. The front side 2 is processed according to a prescription using material-removing processes, such as a milling process.

The spectacle lens blank 1 has a lens element 4 and an annular holder 5. A contour line 6 delimits the finished spectacle lens. A contour line 7 delimits an inner region, namely the lens element 4, which is arranged inside the annular holder 5. An annular surface 8 delimiting the lens element 4 in the radial direction is arranged between the lens element 4 and the annular holder 5.

In the spectacle lens blank 1, the annular surface 8 is a type of imaginary surface. If the annular holder 5 is removed after the processing of the front side 2 of the spectacle lens blank 1, the annular surface 8 forms an outer surface of the lens element 4.

The spectacle lens blank 1 is substantially disk-shaped. The spectacle lens blank 1 has a longitudinal axis L.

An indentation 9 is arranged in the annular holder 5 of the spectacle lens blank 1. The indentation 9 is arranged on the back side 3 of the spectacle lens blank 1. This is the side of the spectacle lens blank 1 completed in a casting process.

The indentation 9 has a radius R1. This means that the indentation 9 is formed with a semi-circular cross-section. The lens element 4 and the annular holder 5 are manufactured from one and the same material, for example from glass or plastic.

In order to manufacture a spectacle lens from the spectacle lens blank 1, the front side 2 of the spectacle lens blank is processed. The processing is carried out, for example, in a CNC-controlled machine (not represented). For example, the front side 2 is ablated by means of a milling cutter until a so-called prescription surface is formed. After the processing operations, such as milling, turning, grinding, fine grinding, and/or polishing, the annular holder 5 is also milled off, specifically up to the contour line 7 of the inner region. This allows a sufficient amount of material to remain on the lens element 4 in order to subsequently fit this into a spectacle frame.

Due to the design of the indentation 9, material of the spectacle lens blank 1 can be saved during the manufacture thereof. The annular holder 5 has a thickness D at the narrowest point, formed by the indentation 9.

The annular surface 8 has a height H.

The height H of the annular surface 8 of the lens element 4 is greater than the thickness D of the annular holder 5 at the narrowest point.

The narrowest point is formed according to FIG. 1 in the region of the indentation 9.

The annular holder 5 thus has a thickness D that is at least partially smaller than the height H of the annular surface.

Due to this design of the spectacle lens blank 1, a considerable amount of material can be saved.

It is important that the spectacle lens blank 1 has an outer surface 10, at which the spectacle lens blank 1 can be clamped in a processing device. The spectacle lens blank 1 is clamped, for example at the outer surface 10, in a chuck of a CNC-controlled processing device (not represented).

The finished spectacle lens 11 has a diameter DB. The lens element 4 has a diameter DL. The lens element 4 has a greater diameter in comparison with the spectacle lens 11, so that this can be fit into a spectacle frame.

The entire spectacle lens blank has an outer diameter AD.

The spectacle lens blank 1 with the lens element 4 and the annular holder 5 is designed as a cast spectacle lens blank 1. The lens element 4 and the annular holder 5 are formed as one piece. Particularly advantageously, the spectacle lens blank 1 with the lens element 4 and the annular holder 5 is designed as a spectacle lens blank 1 cast in a casting process.

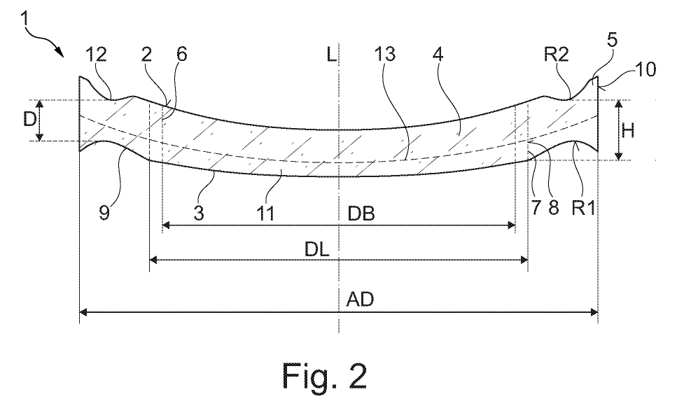

FIG. 2 shows the spectacle lens blank according to FIG. 1. Identical parts are provided with the same reference characters.

According to FIG. 2, the annular holder 5 additionally has an indentation 12 on the front side. This indentation 12 has a radius R2.

This means that the spectacle lens blank 1 according to FIG. 2 has two indentations 9, 12, whereby the material saving is significantly increased.

According to FIG. 2, the spectacle lens blank 1 is milled off on the front side 2 up to a contour line 13, such that a so-called prescription surface is produced along the contour line 13.

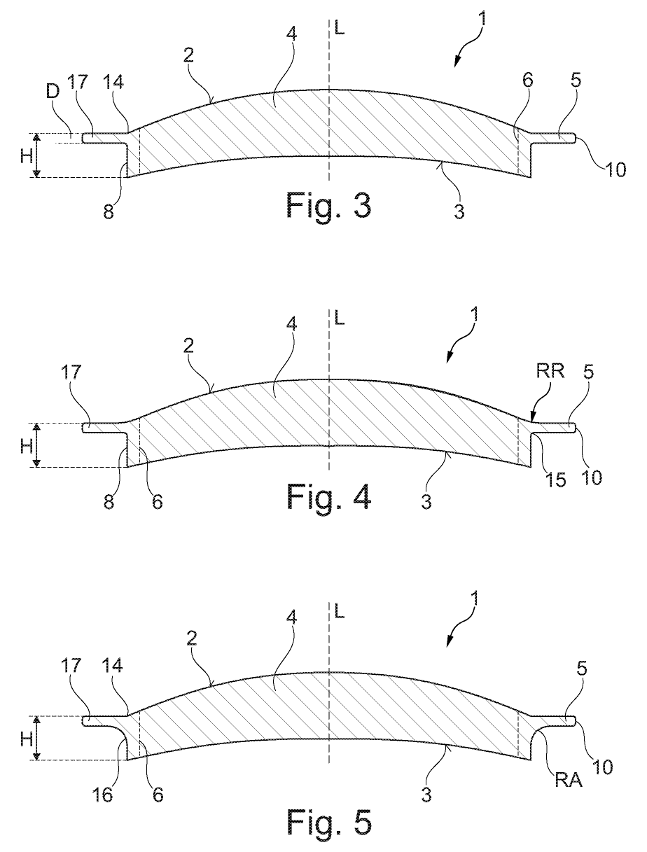

According to FIG. 3, the spectacle lens blank 1 is merely schematically represented. The spectacle lens blank 1 has a lens element 4 and an annular holder 5. The annular holder 5 is designed as a flange 17. Due to this design as a flange 17, a considerably greater amount of material can be saved during the manufacture of the spectacle lens blank 1. An edge 14 is formed between the front side 2 and the flange 17. An edge 15 is formed between the annular surface 8 and the flange 17.

According to FIG. 4, the spectacle lens blank 1 with the lens element 4 and the annular holder 5 is represented. A radius RR is formed between the front side 2 and the flange 17. The edge 15 is formed between the annular surface 8 and the flange 17.

According to FIG. 5, the spectacle lens blank 1 has the lens element 4 and the annular holder 5. The edge 14 is formed between the front side 2 of the spectacle lens blank and the flange 17. A radius RA is formed between an outer surface 16 of the lens element 4 and the flange 17.

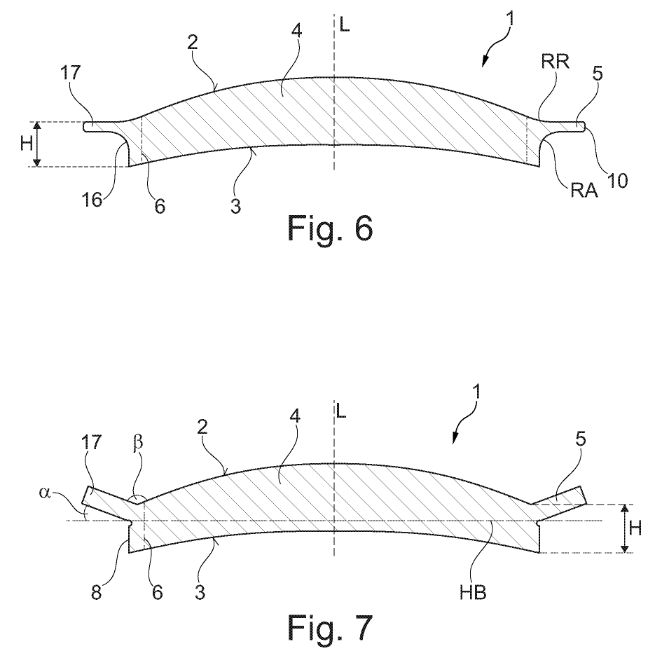

According to FIG. 6, the lens element 4 of the spectacle lens blank 1 has the flange 17. The radius RR is formed between the front side 2 and the flange 17. The radius RA is formed between the outer surface 16 of the lens element 4 and the flange 17.

According to FIG. 7, the spectacle lens blank 1 has the lens element 4 and the flange 17. The spectacle lens blank 1 is disk-shaped. The spectacle lens blank 1 has a horizontal HB. The flange 17 is angled relative to the horizontal HB. Between the flange 17 and the horizontal HB the angle α is formed. Between the flange 17 and the front side 2 the angle β is formed.

The flanges 17 represented in FIGS. 3 through 6 are oriented parallel to the horizontal HB.

The various embodiments can be combined with one another in any way.

A significant advantage of the invention is that material is saved during the manufacture of the spectacle lens blank 1 due to the reduced thickness D of the annular holder 5.

Although only a few embodiments of the present invention have been shown and described, it is to be understood that many changes and modifications may be made thereunto without departing from the spirit and scope of the invention.

### REFERENCE NUMBERS

1 spectacle lens blank
2 front side
3 back side
4 lens element
5 annular holder
6 contour line of finished spectacle lens
7 contour line of inner region
8 annular surface of the lens element
9 indentation
10 outer surface of the spectacle lens blank
11 spectacle lens
12 indentation
13 contour line
14 edge
15 edge
16 outer surface
17 flange
AD outer diameter
D thickness
DB diameter of spectacle lens
DL diameter of lens element
H height of annular surface 8
HB horizontal of the spectacle lens blank
L longitudinal axis
R1 radius
R2 radius
RA radius of outer surface
RR radius of back side
α angle
β angle

What is claimed is:

1. A spectacle lens blank for manufacturing spectacle lenses, which is formed
from a lens element and an annular holder, in which the lens element and the annular
holder are formed from the same material,
wherein an annular surface (8) delimiting the lens element (4) in the radial direction is formed with a height (H) between the lens element (4) and the annular holder (5), and
wherein the annular holder (5) has a thickness (D) that is at least partially smaller than the height (H) of the annular surface (8).

2. The spectacle lens blank of claim 1, wherein the spectacle lens blank (1) with the annular holder (5) and the lens element (4) is designed as a cast spectacle lens blank.

3. The spectacle lens blank of claim 1, wherein the lens element (4) and the annular holder (5) are formed as one piece.

4. The spectacle lens blank of claim 1, wherein the spectacle lens blank (1) with the lens element (4) and the annular holder (5) is designed as a spectacle lens blank cast in a casting process.

5. The spectacle lens blank of claim 1, wherein the thickness (D) of the annular holder (5) is smaller over an entire radial extent of the annular holder (5) than the height (H) of the annular surface (8) between the lens element (4) and the annular holder (5).

6. The spectacle lens blank of claim 1, wherein the annular holder (5) is designed as a flange (17).

7. The spectacle lens blank of claim 6, wherein the flange (17) is designed as a flange (17) which is plane parallel or tapering on one side or as a flange (17) tapering on both sides.

8. The spectacle lens blank of claim 1, wherein the annular holder (5) has at least one indentation (9, 12) on at least one side.

9. The spectacle lens blank of claim 1, wherein a radius (RA, RR) is formed between the lens element (4) and the annular holder (5) on one or both sides (2, 3) of the spectacle lens blank (1).

10. The spectacle lens blank of claim 1, wherein an edge (14, 15) is formed between the lens element (4) and the annular holder (5) on one or both sides (2, 3) of the spectacle lens blank (1).

11. The spectacle lens blank of claim 1, wherein a radius (RA, RR) is formed between the lens element (4) and the annular holder (5) on one side (2, 3) of the spectacle lens blank (1), and wherein an edge (14, 15) is formed between the lens element (4) and the annular holder (5) on the opposite side (2, 3) of the spectacle lens blank (1).

12. The spectacle lens blank of claim 1, wherein the annular holder (5) is arranged parallel to or at an angle to a horizontal (HB) of the spectacle lens blank (1).

13. The spectacle lens blank of claim 1, wherein the spectacle lens blank (1) has a front side (2) and a back side (3), and wherein the front side (2) of the spectacle lens blank (1) is designed as the front side (2) to be processed.
